(19) United States
(12) Patent Application Publication
(10) Pub. No.: US 2012/0033055 A1
(43) Pub. Date: Feb. 9, 2012

(54) Stereoscopic Video Display Apparatus and Display Method

(76) Inventors: Himio Yamauchi, Yokohama-shi (JP); Masatoshi Sano, Fukaya-Shi (JP); Ritsuo Yoshida, Tokyo (JP); Michihiro Fukushima, Tokyo (JP); Masahiro Yamada, Tokyo (JP)

(21) Appl. No.: 13/044,427

(22) Filed: Mar. 9, 2011

(30) Foreign Application Priority Data
Aug. 6, 2010 (JP) 2010-177447

(51) Int. Cl. H04N 13/04

(52) U.S. Cl. 348/51; 348/E13.075

(57) ABSTRACT

In one embodiment, a stereoscopic video display apparatus is configured to assign one subpixel column to each of a plurality of parallax images, and select three subpixels, which are the first to third subpixels, arranged consecutively in the column direction of subpixels with the third subpixel located in the center, as a pixel displaying each parallax image; cause pixels adjacent in the column direction of subpixels in each parallax image to share the first subpixel or the second subpixel; divide each of frames displaying a stereoscopic video into two subframes; assign one pixel from among the plurality of parallax images to each row in each subframe; display odd-numbered rows when displaying one of the first and second subframes; and display even-numbered rows when displaying the other of the first and second subframes.

### CROSS-REFERENCE TO RELATED APPLICATION

This application is based upon and claims the benefit of priority from prior Japanese Patent Application No. 2010-177447 filed on Aug. 6, 2010 in Japan, the entire contents of which are incorporated herein by reference.

### FIELD

Embodiments described herein relate generally to a stereoscopic video display apparatus and a display method.

### BACKGROUND

As to the stereoscopic video display apparatus, which is the so-called three-dimensional display, various schemes are known. In recent years, demands for a scheme which is for a flat panel type and which does not need dedicated glasses have increased. In stereoscopic moving picture display apparatuses of this type, there are also apparatuses which utilize the principle of the holography. However, it is difficult to put them to practical use. A scheme in which an optical plate is installed immediately before a display panel (plane display device) having fixed pixel positions, such as a direct view type or projection type liquid crystal display device or plasma display device, to control light rays supplied from the display panel and direct the light rays to a viewer is known as a scheme which can be implemented with comparative ease.

The optical plate is typically called parallax barrier as well. The optical plate controls light rays to make different images visible from different angles even in the same position on the optical plate. Specifically, in the case where only lateral disparity (horizontal disparity) is given, a slit or lenticular sheet (cylindrical lens array) is used. In the case where up-and-down disparity (vertical disparity) is also included, a pinhole array or a lens array is used. The schemes using the parallax barrier are further classified into the binocular scheme, multiview scheme, super-multiview scheme (super-multiview condition of the multiview scheme), and integral photography (hereafter referred to as IP as well). The basic principle of them is substantially the same as the principle which has been used in stereoscopic photograph invented approximately 100 years ago.

Among them, the IP scheme has a feature that the degree of freedom of the viewpoint position is high and the stereoscopic view can be obtained easily. In the IP scheme in which there is only horizontal disparity and there isn't vertical disparity, it is also possible to implement a display device having high resolution with comparative ease. On the other hand, in the binocular scheme and multiview scheme, there is a problem that the range of the viewpoint position which allows stereoscopic view, i.e., the viewing zone is narrow and it is hard to view. However, the configuration of the stereoscopic video display apparatus is the simplest, and the display image can be generated simply.

In such a direct view type autostereoscopic video display apparatus using a slit or lenticular sheet, moiré or color moiré is apt to be generated by interference between a periodic structure of optical apertures of the optical plate and a periodic structure of pixels of the plane display device. As its countermeasure, a method of using lateral stripe arrangement as the color arrangement of pixels is known.

If the lateral stripe arrangement is used as the color arrangement of pixels, however, there is a problem in the conventional stereoscopic video display apparatus that the number of subpixels forming RGB to display an elemental image which is a set of parallax images assigned to the same optical aperture part does not decrease and the resolution does not increase.

### BRIEF DESCRIPTION OF THE DRAWINGS

FIG. 1 is a diagram showing a configuration of a stereoscopic video display apparatus according to an embodiment;

FIGS. 2(a) and 2(b) are diagrams showing an optical plate used in a stereoscopic video display apparatus according to an embodiment;

FIG. 3 is a diagram showing an arrangement of R, G and B subpixels in a stereoscopic video display apparatus according to an embodiment;

FIG. 4 is a diagram for explaining one frame in a stereoscopic video display apparatus according to an embodiment;

FIG. 5 is a diagram for explaining display of a first subframe parallax image in a stereoscopic video display apparatus according to an embodiment;

FIG. 6 is a diagram for explaining display of a second subframe parallax image in a stereoscopic video display apparatus according to an embodiment; and

FIG. 7 is a diagram for explaining display of a parallax image in a stereoscopic video display apparatus according to a comparative example.

### DETAILED DESCRIPTION

In one embodiment, a stereoscopic video display apparatus includes: a plane display unit configured to include a display screen in which first to third subpixels having respectively different color components are arranged in a matrix form; an optical plate configured to be disposed to be opposed to the plane display unit, the optical plate having a plurality of optical apertures, a direction of extension of the optical apertures being substantially parallel to a column direction of subpixels on the display screen, light rays from the plane display unit being controlled by the optical plate; and a drive unit configured to send data to the plane display unit, assign the data to the first to third subpixels in the plane display unit, and drive the plane display unit to display a stereoscopic video. The plane display unit includes a configuration obtained by arranging the first subpixels on a first subpixel row, arranging the third subpixels on a second subpixel row adjacent to the first subpixel row, arranging the second subpixels on a third subpixel row adjacent to the second subpixel row, arranging the third subpixels on a fourth subpixel row adjacent to the third subpixel row, and arranging a set of the first to fourth subpixel rows in the column direction of subpixels on the display screen repeatedly. The drive unit drives the plane display unit and thereby: assigns an elemental image including a plurality of parallax images to each optical aperture and assigns an elemental image display region in the plane display unit to each elemental image; assigns one subpixel column to each parallax image, and selects three subpixels, which are the first to third subpixels, arranged consecutively in the column direction of subpixels with the third subpixel located in the center, as a pixel displaying each parallax image; causes pixels adjacent in the column direction of subpixels in each parallax image to share the first subpixel or the second subpixel; divides each of frames displaying a stereoscopic video into two subframes; assignes one pixel from among the plurality of parallax images to each row in each subframe; displays odd-numbered rows when displaying one of the first and second subframes; and displays even-numbered rows when displaying the other of the first and second subframes.

Hereafter, an embodiment will be described more specifically with reference to the drawings. Throughout the drawings, components having the same or similar functions are denoted by like reference numerals, and description for such components will not be repeated.

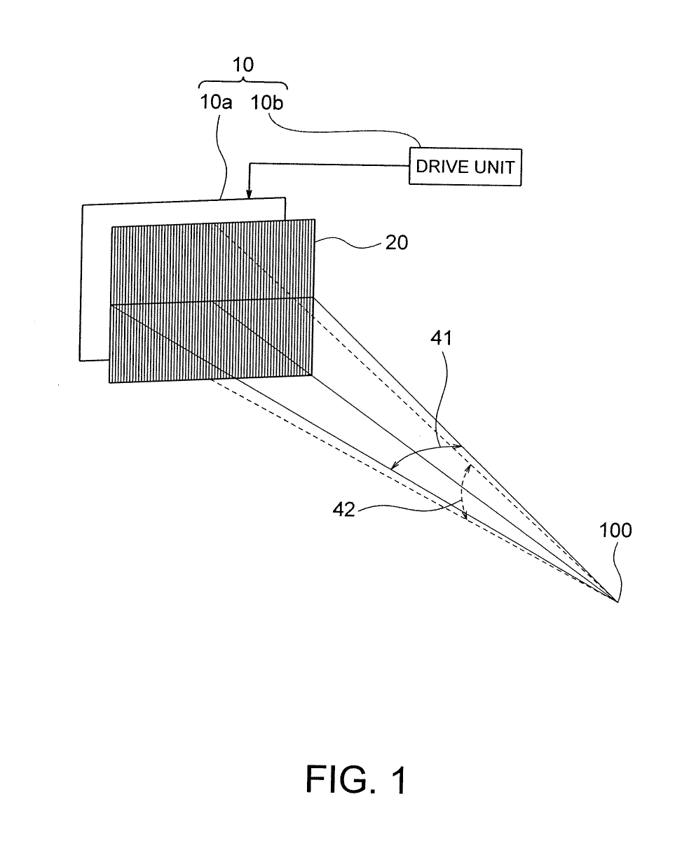

A stereoscopic video display apparatus according to an embodiment of the present invention will be described with reference to the drawings. FIG. 1 shows a typical configuration of the stereoscopic video display apparatus. The stereoscopic video display apparatus shown in FIG. 1 includes a plane display device 10 and an optical plate 20. The plane display device 10 includes a plane display unit (referred to as display panel as well) 10a having a display screen formed of pixels arranged in a matrix form, and a drive unit 10b which drives the plane display unit 10a. The optical plate 20 is provided in front of the plane display unit 10a, and the optical plate 20 includes optical aperture parts to control light rays supplied from the pixels in the plane display unit 10a. It becomes possible to view a stereoscopic image in front of and behind the optical plate 20 by viewing light rays, which are emitted from the plane display unit 10a via the optical plate 20, from a position 100 of eyes of the viewer, in a range of a viewing angle 41 in the horizontal direction and a viewing angle of 42 in the vertical direction. By the way, the optical aperture part is a physical aperture part in the case where the optical plate is a slit, whereas the optical aperture part is each cylindrical lens in the case where the optical plate is a lenticular sheet. In these cases, there is parallax only in a horizontal direction 41 and an image changes according to the viewing distance. Since there is no parallax in a vertical direction 42, however, a constant video is perceived regardless of the viewing position. In some cases, a spacer is provided between the plane display unit 10a and the optical plate 20 to adjust the focal length.

As long as pixels having determined positions in the display screen are arranged in a planar matrix form, the plane display unit 10a may be a display panel such as a liquid crystal display device of direct view type or projection type, a plasma display device, an electric field emission type display device, or an organic EL display device. The drive unit 10b sends display data to the plane display unit 10a, assigns the display data to the pixels in the plane display unit 10a, and drives the stereoscopic video display apparatus to display a stereoscopic video. The drive unit 10b may be integral with the plane display unit 10a, or may be provided outside of the plane display unit 10a.

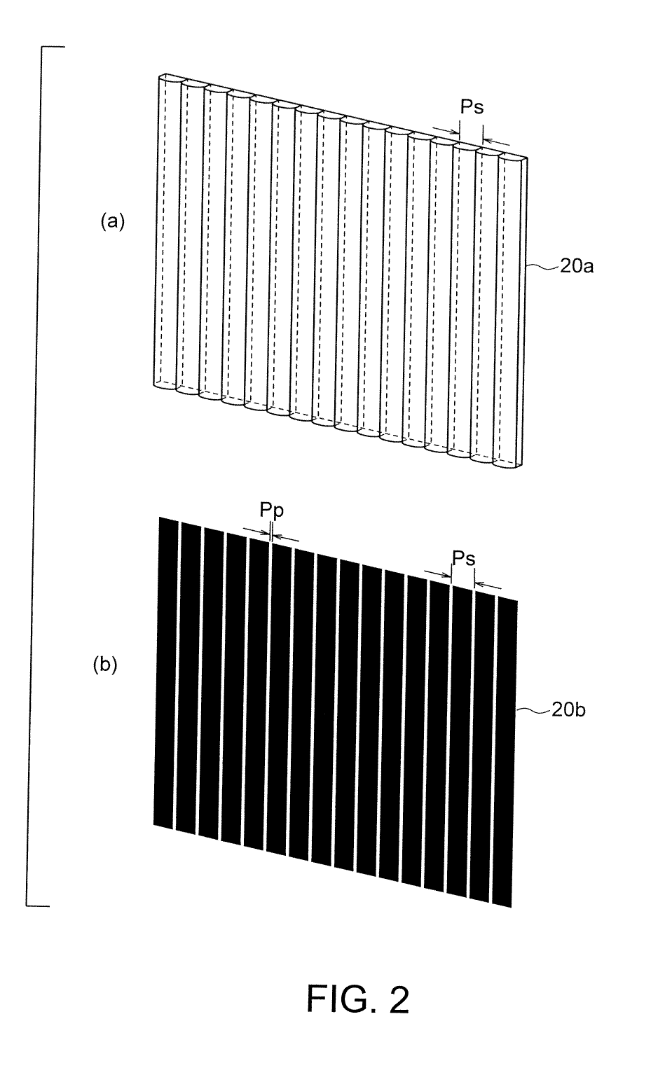

Furthermore, in the configuration of the stereoscopic video display apparatus according to the present embodiment, the extension direction of the optical aperture parts of the optical plate 20 is made parallel to the longitudinal direction (vertical direction) of the display screen in the plane display unit 10a. For example, an oblique view in the case where the optical plate 20 is a lenticular sheet 20a formed of a plurality of cylindrical lenses 21 is shown in FIG. 2(a), and an oblique view in the case where the optical plate 20 is a slit 20b is shown in FIG. 2(b). In FIGS. 2(a) and 2(b), Ps denotes a pitch of the optical aperture parts in the optical plate 20. In FIG. 2(b), Pp denotes a size of an aperture part in the slit.

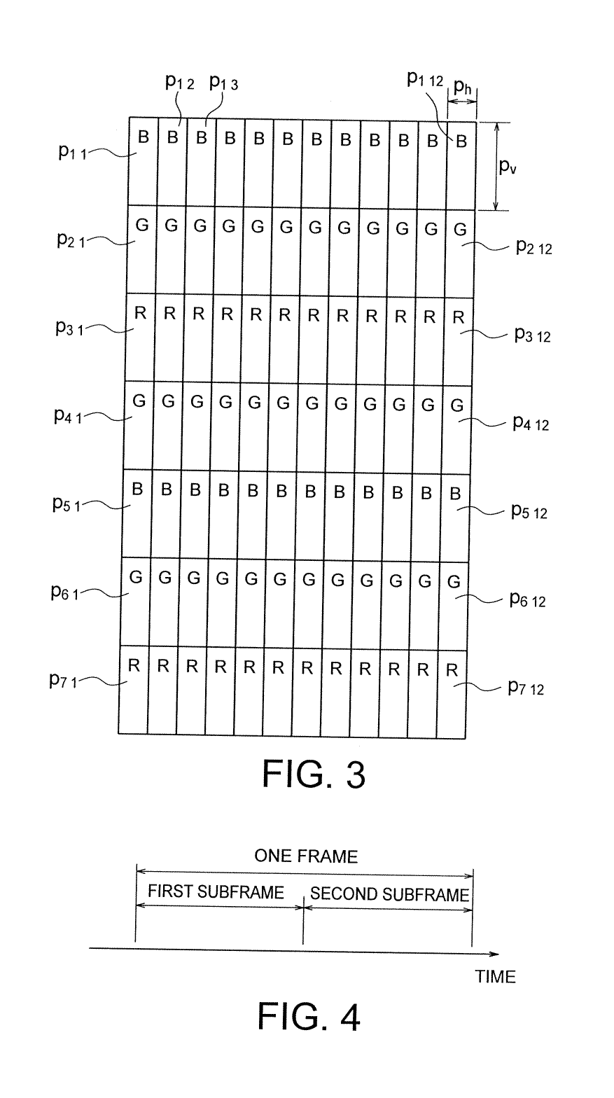

In the stereoscopic video display apparatus according to the present embodiment, the display screen of the plane display unit 10a has R (red), G (green) and B (blue) subpixels arranged in an array form. By the way, the R (red), G (green) and B (blue) subpixels are implemented by suitably arranging color filters on the display screen. In the present embodiment, the direction of extension of the optical aperture parts in the optical plate 20 is parallel to the longitudinal direction (vertical direction) of the display screen in the plane display unit 10a, and consequently the direction is parallel to the column direction of subpixels. In the present embodiment, each subpixel includes an aperture part and a black matrix. Therefore, the subpixels are arranged in the longitudinal direction and the lateral direction to be adjacent to each other. Each subpixel has a longitudinal to lateral size ratio of 3:1. In other words, denoting a pitch of subpixels in the lateral direction (horizontal direction) by pₕ and denoting a pitch of subpixels in the longitudinal direction (vertical direction) by pᵥ, the relation pₕ/pᵥ=1/3 is satisfied (see FIG. 3).

Arrangement of the R, G and B subpixels in the present embodiment is shown in FIG. 3. As shown in FIG. 3, B subpixels are arranged in a first subpixel row. G subpixels are arranged in a second subpixel row. R subpixels are arranged in a third subpixel row. G subpixels are arranged in a fourth subpixel row. B subpixels are arranged in a fifth subpixel row. G subpixels are arranged in a sixth subpixel row. R subpixels are arranged in a seventh subpixel row. In other words, a set of the first to the fourth subpixel rows is arranged in the vertical direction of the display screen (the column direction of subpixels) repeatedly. By the way, a configuration in which only B subpixels are arranged in the first subpixel row, only G subpixels are arranged in the second subpixel row, only R subpixels are arranged in the third subpixel row, only G subpixels are arranged in the fourth subpixel row, only B subpixels are arranged in the fifth subpixel row, only G subpixels are arranged in the sixth subpixel row, and only R subpixels are arranged in the seventh subpixel row is desirable. The present embodiment has a configuration in which a subpixel row formed of B subpixels, a subpixel row formed of G subpixels, and a subpixel row formed of R subpixels are provided next to a final set in the cited order. Furthermore, a configuration in which a subpixel row formed of only B subpixels, a subpixel row formed of only G subpixels, and a subpixel row formed of only R subpixels are provided next to the final set in the cited order is desirable.

For example, as shown in FIG. 3, the arrangement of subpixels is represented by p_{i j} (i=1, . . . , 7, j=1, . . . , 12). In other words, p_{i j} (i=1, . . . , 7, j=1, . . . , 12) represents a subpixel in an i-th subpixel row and a j-th subpixel column. In the present embodiment, a subpixel p_{1 k} (k=1, . . . , 12) in a first subpixel row is a B subpixel. A subpixel p_{2 j} (j=1, . . . , 12) in a second subpixel row and a subpixel p_{4 j} (j=1, . . . , 12) in a fourth subpixel row are G subpixels. A subpixel p_{3 k} (k=1, . . . , 12) in a third subpixel row is an R subpixel. A set of the first to fourth subpixel rows is arranged in the vertical direction of the display screen repeatedly. By the way, only one set of the first to fourth subpixel rows is shown in FIG. 3. And the present embodiment has a configuration in which a subpixel row formed of B subpixels, a subpixel row formed of G subpixels, and a subpixel row formed of R subpixels are provided next to the final set in the cited order.

In general, in the stereoscopic video display apparatus, an elemental image which is a set of parallax images assigned to the same aperture of the optical plate includes numbered parallax images. In the present embodiment, therefore, one parallax image is assigned to each subpixel row. Furthermore, in the present embodiment, one frame of a displayed video is divided into a first subframe and a second subframe as shown in FIG. 4. Control of such display is performed by the drive unit 10b.

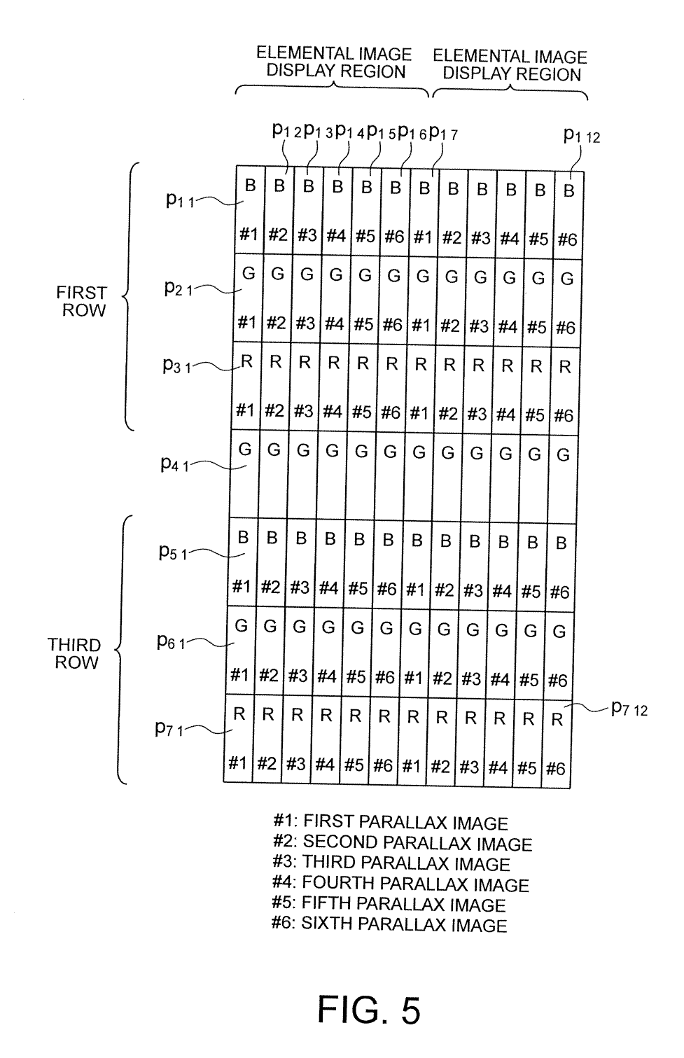

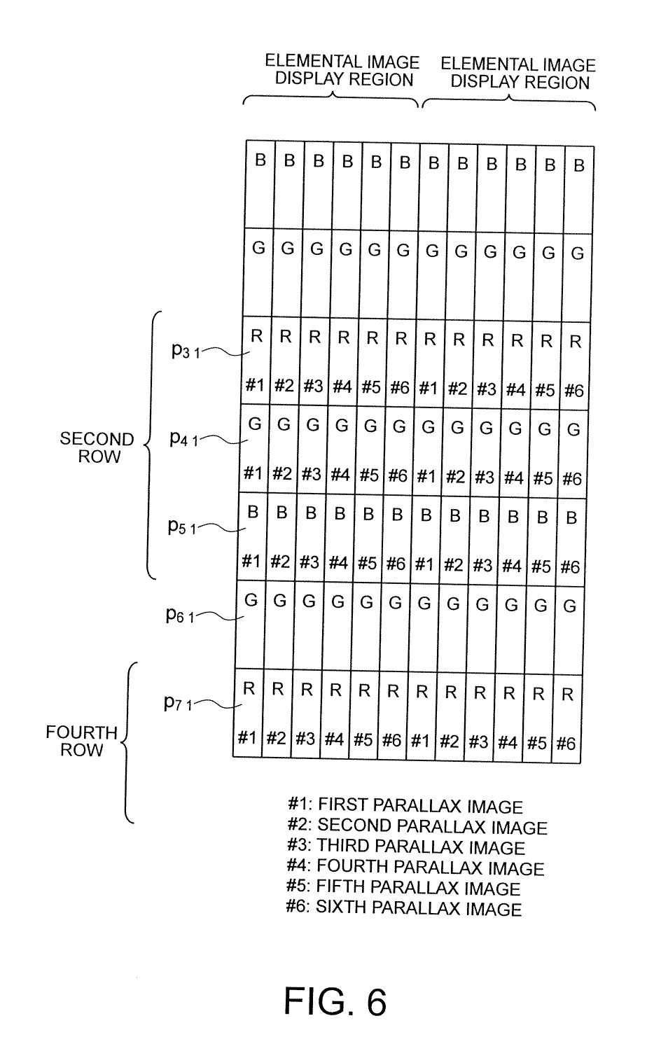

Such divisional display in two subframes will now be described as to the case where the elemental image is formed of six parallax images, with reference to FIGS. 5 and 6. FIG. 5 shows a display example of parallax images in the case where parallax images are displayed in the first subframe. FIG. 6 shows a display example of parallax images in the case where parallax images are displayed in the second subframe.

In the first subframe, only odd-numbered rows are displayed as shown in FIG. 5. In other words, a first parallax image (denoted by #1) of one elemental image (for example, a first elemental image) is displayed by using subpixels p_{1 1}, p_{2 1}, p_{3 1}, p_{5 1}, p_{6 1} and p_{7 1}. A second parallax image (denoted by #2) is displayed by using subpixels p_{1 2}, p_{2 2}, p_{3 2}, p_{5 2}, p_{6 2} and p_{7 2}. A third parallax image (denoted by #3) is displayed by using subpixels p_{1 3}, p_{2 3}, p_{3 3}, p_{5 3}, p_{6 3} and p_{7 3}. A fourth parallax image (denoted by #4) is displayed by using subpixels p_{1 4}, p_{2 4}, p_{3 4}, p_{5 4}, p_{6 4} and p_{7 4}. A fifth parallax image (denoted by #5) is displayed by using subpixels p_{1 5}, p_{2 5}, p_{3 5}, p_{5 5}, p_{6 5} and p_{7 5}. A sixth parallax image (denoted by #6) is displayed by using subpixels p_{1 6}, p_{2 6}, p_{3 6}, p_{5 6}, p_{6 6} and p_{7 6}. In other words, G subpixels in the fourth subpixel row are brought into the non-display state.

By the way, the subpixels p_{1 7}, p_{2 7}, p_{3 7}, p_{5 7}, p_{6 7} and p_{7 7} display a first parallax image of a second elemental image corresponding to an optical aperture which is adjacent in a rightward direction to an optical aperture of the optical plate 20 corresponding to the first elemental image. A set of subpixels displaying one elemental image is referred to as elemental image display region. In other words, the elemental image display region includes subpixels which display odd-numbered parallax images and subpixels which display even-numbered parallax images.

In FIG. 5, a set of subpixels p_{1 1}, p_{2 1} and p_{3 1} displaying a first parallax image in the first elemental image represents one pixel (for example, a first pixel) formed of B, G and R subpixels. A set of subpixels p₅₁, p₆₁ and p₇₁ displaying the first parallax image represents one pixel (for example, a third pixel) formed of B, G and R subpixels which is located at one pixel apart in vertical downward direction from the first pixel when displaying the same parallax image. In other words, the first pixel and the third pixel are pixels which are at one pixel apart from each other in the vertical direction when displaying the first parallax images respectively. And when displaying parallax images, there is a G subpixel (for example, a subpixel p_{4 1}) which assumes a non-display state between the two pixels which are at one pixel apart from each other in the vertical direction. Such pixel assignment is conducted by the drive unit 10b. This is also true in the case where other parallax images are displayed in the first frame.

In this way, in each parallax image, a G subpixel, a B subpixel which is located above and adjacent to the G subpixel, and an R subpixel which is located below and adjacent to the G subpixel constitute one pixel which displays one parallax image as shown in FIG. 5. In other words, three subpixels having the G subpixel at the center and other two subpixels respectively located above and below the G subpixel to be adjacent to the G subpixel constitute one pixel which displays one parallax image.

And each elemental image has a configuration in which each pixel which displays an odd-numbered parallax image (for example, a pixel formed of subpixels p_{1 1}, p_{2 1} and p_{3 1} which displays the first parallax image) and each pixel which displays a parallax image having an even number adjacent to the odd number (for example, a pixel formed of subpixels p_{1 2}, p_{2 2} and p_{3 2} which displays the second parallax image) are arranged to be adjacent to each other in the horizontal direction.

In addition, in each elemental image, a pixel located at the top in the vertical direction as an odd-numbered parallax image (for example, a pixel formed of subpixels p_{1 1}, p_{2 1} and p_{3 1}) is disposed in first to third subpixel rows of the odd-numbered subpixel column in the elemental image display region, and a pixel located at the top in the vertical direction as an even-numbered parallax image (for example, a pixel formed of subpixels p_{1 2}, p_{2 2} and p_{3 2}) is disposed in the first to third subpixel rows of the even-numbered subpixel column in the elemental image display region. Such assignment of parallax images to the elemental image display regions is performed as a result of driving of the plane display unit 10a performed by the drive unit 10b.

In the first and second subframes in the present embodiment, first to third subpixel rows constitute a first row of each subframe, third to fifth subpixel rows constitute a second row of each subframe, and fifth to seventh subpixel rows constitute a third row of each subframe. In other words, each row in each subframe is formed of three subpixel rows, and adjacent rows share one subpixel row. In the first subframe shown in FIG. 5, only odd-numbered rows are brought into the display state whereas even-numbered rows are brought into the non-display state as a result of driving performed by the drive unit 10b.

On the other hand, in the second subframe, only even-numbered rows are displayed and odd-numbered rows are not displayed as shown in FIG. 6. In other words, a first parallax image (denoted by #1) of one elemental image (for example, a first elemental image) is displayed by using subpixels p_{3 1}, p_{4 1}, p_{5 1} and p_{7 1}. A second parallax image (denoted by #2) is displayed by using subpixels p_{3 2}, p_{4 2}, p_{5 2} and p_{7 2}. A third parallax image (denoted by #3) is displayed by using subpixels p_{3 3}, p_{4 3}, p_{5 3} and p_{7 3}. A fourth parallax image (denoted by #4) is displayed by using subpixels p_{3 4}, p_{4 4}, p_{5 4} and p_{7 4}. A fifth parallax image (denoted by #5) is displayed by using subpixels p_{3 5}, p_{4 5}, p_{5 5} and p_{7 5}. A sixth parallax image (denoted by #6) is displayed by using subpixels p_{3 6}, p_{4 6}, p_{5 6} and p_{7 6}. In other words, G subpixels in the second and sixth subpixel rows are brought into the non-display state.

By the way, the subpixels p₃₇, p₄₇, p₅₇ and p₇₇ display a first parallax image of a second elemental image corresponding to an optical aperture which is adjacent in a rightward direction to an optical aperture of the optical plate 20 corresponding to the first elemental image.

Furthermore, for example, the subpixel p₇₁ displays a pixel which is at one pixel apart in the vertical direction from a pixel displayed by the subpixels p_{3 1}, p_{4 1} and p_{5 1} in the first parallax image.

In the second subframe as well, there is a G subpixel (for example, a subpixel p_{6 1}) which assumes a non-display state between the two pixels which are at one pixel apart from each other in the vertical direction when displaying each parallax image as shown in FIG. 6 in the same way as the first subframe. Such pixel assignment is performed by the drive unit 10b.

In this way, in each parallax image, a G subpixel, an R subpixel which is located above and adjacent to the G subpixel, and a B subpixel which is located below and adjacent to the G subpixel constitute one pixel which displays one parallax image as shown in FIG. 6. In other words, three subpixels having the G subpixel at the center and other two subpixels respectively located above and below the G subpixel to be adjacent to the G subpixel constitute one pixel which displays one parallax image.

And each elemental image has a configuration in which each pixel which displays an even-numbered parallax image (for example, a pixel formed of subpixels p_{3 2}, p_{4 2} and p_{5 2} which displays the second parallax image) and each pixel which displays a parallax image having an odd number adjacent to the even number (for example, a pixel formed of subpixels p_{3 1}, p_{4 1} and p_{5 1} which displays the first parallax image) are arranged to be adjacent to each other in the horizontal direction.

In addition, in each elemental image, a pixel located at the top in the vertical direction as an even-numbered parallax image (for example, a pixel formed of subpixels p_{3 2}, p_{4 2} and p_{5 2}) is disposed in third to fifth subpixel rows of the even-numbered subpixel column in the elemental image display region, and a pixel located at the top in the vertical direction as an odd-numbered parallax image (for example, a pixel formed of subpixels p_{3 1}, p_{4 1} and p_{5 1}) is disposed in the third to fifth subpixel rows of the odd-numbered subpixel column in the elemental image display region. Such assignment of parallax images to the elemental image display regions is performed as a result of driving of the plane display unit 10a performed by the drive unit 10b.

In FIG. 6, first to third subpixel rows constitute a first row of the second subframe, third to fifth subpixel rows constitute a second row of the second subframe, and fifth to seventh subpixel rows constitute a third row of the second subframe. In other words, each row in the second subframe is formed of three subpixel rows, and adjacent rows share one subpixel row. In the second subframe shown in FIG. 6, only even-numbered rows are brought into the display state whereas odd-numbered rows are brought into the non-display state as a result of driving performed by the drive unit 10b.

In the present embodiment having such a configuration, the number of subpixels displaying the same parallax image is represented by 2N+1, where N denotes the number of rows in each subframe. This is because adjacent rows in each subframe share one subpixel row and each row has one subpixel row which displays G (green).

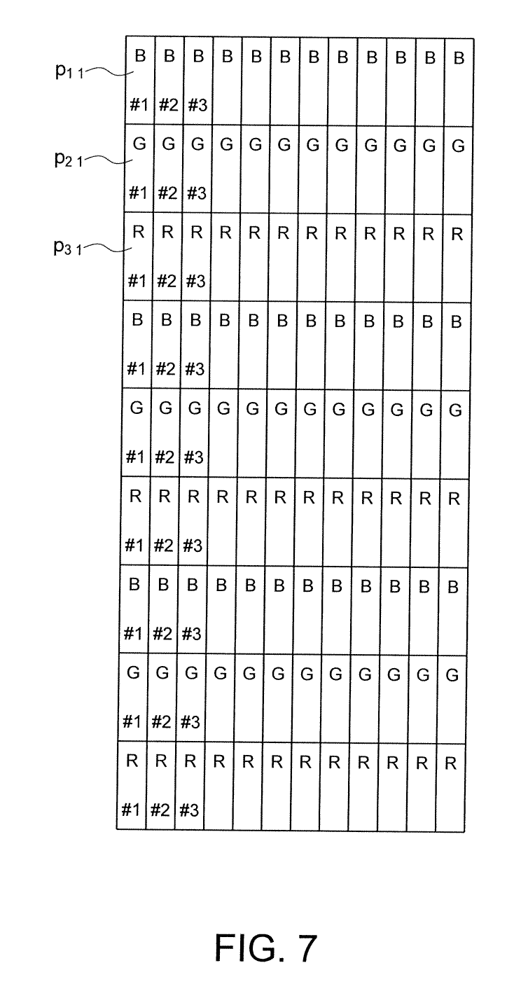

On the other hand, FIG. 7 shows a comparative example in which R, G and B subpixels are arranged in a lateral stripe form. A stereoscopic video display apparatus according to the comparative example has a configuration in which a set of a B subpixel row, a G subpixel row and an R subpixel row is arranged in the vertical direction of the display screen (the column direction of subpixels) repeatedly. In a stereoscopic video display apparatus according to the comparative example as well, the direction of extension of optical apertures of the optical plate is parallel to the longitudinal direction of the display screen in the plane display unit, in the same way as the present embodiment. In this comparative example, the number of subpixels which display the same parallax image is represented by 3N, where the number of rows in each frame is denoted by N. This is because in the case of the lateral stripe arrangement shown in FIG. 7, the same parallax image is displayed by the same subpixel column; R, G and B subpixels (for example, p_{1 1}, p_{2 1} and p_{3 1}) which are consecutive in the same subpixel column constitute one pixel; and each row in each frame corresponds to three subpixel rows. By the way, the comparative example in which R, G and B subpixels are arranged in the lateral stripe form is used in the conventional stereoscopic video display apparatus.

As will be understood from the foregoing description, when displaying the same parallax image according to the present embodiment, it is possible to display it with subpixels which are less in number as compared with the comparative example. This means that a larger number of parallax images can be displayed with a smaller number of subpixels. As a result, the resolution can be increased.

Remarking only G subpixels in the case where the first subframe is displayed as shown in FIG. 5 in the present embodiment, G subpixels in the display state and G subpixels in the non-display state appear alternately in the subpixel row direction. In the case where the second frame is displayed as shown in FIG. 6, G subpixels in the display state and G subpixels in the non-display state appear alternately in the subpixel column direction. However, positions of G subpixels in the display state and the non-display state in the first subframe are opposite to positions of G subpixels in the display state and the non-display state in the second subframe. In other words, in the first subframe, the second and sixth subpixel rows formed of G subpixels assume the display state and the fourth subpixel row formed of G subpixels assumes the non-display state, as shown in FIG. 5. On the other hand, in the second subframe, the second and sixth subpixel rows formed of G subpixels assume the non-display state and the fourth subpixel row formed of G subpixels assumes the display state.

And an R subpixel (for example, p_{1 3}) on an odd-numbered row in the first subframe is used as an R subpixel on an even-numbered row adjacent to the odd-numbered row when a parallax image having the same number as that of a parallax image displayed by the R subpixel is displayed in the second subframe. Furthermore, a B subpixel (for example, p_{5 1}) on an odd-numbered row in the first subframe is used as a B subpixel on an even-numbered row adjacent to the odd-numbered row when a parallax image having the same number as that of a parallax image displayed by the B subpixel is displayed in the second subframe.

By the way, as a first modification of the present embodiment, a stereoscopic video display apparatus may have an arrangement in which G subpixels are interchanged with R subpixels.

Furthermore, as a second modification of the present embodiment, a stereoscopic video display apparatus may have an arrangement in which G subpixels are interchanged with B subpixels.

By the way, since G (green) becomes dominant on the luminance component as compared with R (red) or B (blue), the stereoscopic video display apparatus according to the present embodiment is more desirable than the first modification and the second modification.

Furthermore, as a third modification of the present embodiment, a stereoscopic video display apparatus may have an arrangement in which B subpixels are interchanged with R subpixels.

The embodiment is nothing but an example, and the scope of the invention is not restricted thereby.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A stereoscopic video display apparatus comprising:
a plane display unit configured to include a display screen in which first to third subpixels having respectively different color components are arranged in a matrix form;
an optical plate configured to be disposed to be opposed to the plane display unit, the optical plate having a plurality of optical apertures, a direction of extension of the optical apertures being substantially parallel to a column direction of subpixels on the display screen, light rays from the plane display unit being controlled by the optical plate; and
a drive unit configured to send data to the plane display unit, assign the data to the first to third subpixels in the plane display unit, and drive the plane display unit to display a stereoscopic video,
the plane display unit including a configuration obtained by arranging the first subpixels on a first subpixel row, arranging the third subpixels on a second subpixel row adjacent to the first subpixel row, arranging the second subpixels on a third subpixel row adjacent to the second subpixel row, arranging the third subpixels on a fourth subpixel row adjacent to the third subpixel row, and arranging a set of the first to fourth subpixel rows in the column direction of subpixels on the display screen repeatedly,
the drive unit driving the plane display unit and thereby:
assigning an elemental image including a plurality of parallax images to each optical aperture and assigning an elemental image display region in the plane display unit to each elemental image;
assigning one subpixel column to each parallax image, and selecting three subpixels, which are the first to third subpixels, arranged consecutively in the column direction of subpixels with the third subpixel located in the center, as a pixel displaying each parallax image;
causing pixels adjacent in the column direction of subpixels in each parallax image to share the first subpixel or the second subpixel;
dividing each of frames displaying a stereoscopic video into two subframes;
assigning one pixel from among the plurality of parallax images to each row in each subframe;
displaying odd-numbered rows when displaying one of the first and second subframes; and
displaying even-numbered rows when displaying the other of the first and second subframes.

2. The stereoscopic video display apparatus according to claim 1, wherein the plane display unit further includes a configuration obtained by providing a subpixel row formed of the first subpixels, a subpixel row formed of the third subpixels, and a subpixel row formed of the second subpixels in the cited order next to a final set in the repeatedly arranged sets.

3. The stereoscopic video display apparatus according to claim 1, wherein the drive unit drives the plane display unit to cause positions of rows formed of the third subpixels in a display state and rows formed of the third subpixels in a non-display state when the one subframe is displayed to be opposite to positions of rows formed of the third subpixels in the display state and rows formed of the third subpixels in the non-display state when the other subframe is displayed.

4. The stereoscopic video display apparatus according to claim 1, wherein
the plurality of parallax images included in the elemental image are assigned numbers,
a first subpixel on an odd-numbered row in the one subframe is used as a first subpixel on an even-numbered row adjacent to the odd-numbered row when a parallax image having same number as that of a parallax image displayed by the first subpixel is displayed in the other subframe, and
a second subpixel on the odd-numbered row in the one subframe is used as a second subpixel on an even-numbered row adjacent to the odd-numbered row when a parallax image displayed by the second subpixel is displayed in the other subframe.

5. The stereoscopic video display apparatus according to claim 1, wherein
the plurality of parallax images included in the elemental image are provided with numbers, and
the drive unit drives the plane display unit to:
provide subpixel columns included in each elemental image display region with numbers and assign to the subpixel column a parallax image having a same number as a number assigned to each subpixel column, and
with respect to each elemental image, cause a pixel which displays each parallax image when displaying the one subframe to consist of the first subpixel, the third subpixel and the second subpixel in the cited order from top, and cause a pixel which displays each parallax image when displaying the other subpixel to consist of the second subpixel, the third subpixel and the first subpixel in the cited order from top.

6. The stereoscopic video display apparatus according to claim 1, wherein the third subpixel is a G subpixel, and one of the first and second subpixels is an R subpixel whereas the other of the first and second subpixels is a B subpixel.

7. The stereoscopic video display apparatus according to claim 1, wherein the optical plate is a lenticular sheet.

8. The stereoscopic video display apparatus according to claim 1, wherein the optical plate is a slit.

9. A method for displaying a stereoscopic video by using a stereoscopic video display apparatus comprising a plane display unit including a display screen in which first to third subpixels having respectively different color components are arranged in a matrix form, the method for displaying a stereoscopic video comprising:
assigning one subpixel column to each of a plurality of parallax images, and selecting three subpixels, which are the first to third subpixels, arranged consecutively in the column direction of subpixels with the third subpixel located in the center, as a pixel displaying each parallax image;
causing pixels adjacent in the column direction of subpixels in each parallax image to share the first subpixel or the second subpixel;
dividing each of frames displaying a stereoscopic video into two subframes;
assigning one pixel from among the plurality of parallax images to each row in each subframe;
displaying odd-numbered rows when displaying one of the first and second subframes; and
displaying even-numbered rows when displaying the other of the first and second subframes.
